(19) United States
(12) Patent Application Publication
(10) Pub. No.: US 2012/0027951 A1
(43) Pub. Date: Feb. 2, 2012

(54) METHOD FOR FORMING ANTENNA STRUCTURE

(75) Inventors: Sheng-Chieh Chang, Hsinchu (TW); Bau-Yi Huang, Hsinchu (TW); Chi-Wen Tsai, Hsinchu (TW); Hsin-Hui Hsu, Hsinchu (TW); Wen-Kuei Lo, Hsinchu (TW)

(73) Assignee: WISTRON NEWEB CORP., Hsinchu (TW)

(21) Appl. No.: 13/014,488

(22) Filed: Jan. 26, 2011

(30) Foreign Application Priority Data
Jul. 27, 2010 (TW) TW99124659

(51) Int. Cl. B05D 3/06

(52) U.S. Cl. 427/558; 427/553

(57) ABSTRACT

A method for forming an antenna structure is provided, including the following steps of: providing a non-conductive frame and forming a photosensitive medium layer on the non-conductive frame, wherein the medium layer comprises a catalyzer for electroless deposition; applying a light beam through a transparent portion of a mask to the medium layer, such that a part of the medium layer is solidified within a predetermined region on the non-conductive frame; removing a part of the medium layer outside of the predetermined region; and forming a metal layer on the medium layer within the predetermined region.

### CROSS REFERENCE TO RELATED APPLICATIONS

This Application claims priority of Taiwan Patent Application No. 099124659, filed on Jul. 27, 2010, the entirety of which is incorporated by reference herein.

### BACKGROUND OF THE INVENTION

1. Field of the Invention

This application relates in general to a method for forming an antenna structure and in particular to a method for forming an antenna structure on a non-conductive frame.

2. Description of the Related Art

In conventional mobile phones, the antennas are usually thin metal pieces having specific patterns fixed to a plastic housing. The assembly process for fixing the antennas may require considerable time and production costs. To solve the aforesaid problems, simplifying the assembly process and reducing cost in producing the antennas have become important issues.

### BRIEF SUMMARY OF INVENTION

This application provides a method for forming an antenna structure, including the steps of: providing a non-conductive frame and forming a photosensitive medium layer on the non-conductive frame, wherein the medium layer comprises a catalyzer for electroless deposition; applying a light beam through a transparent portion of a mask to the medium layer, such that a part of the medium layer is solidified within a predetermined region on the non-conductive frame; removing a part of the medium layer outside of the predetermined region; and forming a metal layer on the medium layer within the predetermined region.

### BRIEF DESCRIPTION OF DRAWINGS

The invention can be more fully understood by reading the subsequent detailed description and examples with references made to the accompanying drawings, wherein:

FIG. 1 is a perspective diagram of a non-conductive frame according to an embodiment of the invention;

FIG. 2 is a perspective diagram of a non-conductive frame immersed in a photosensitive material;

FIG. 3 is a perspective diagram of a light beam applied through a mask to a predetermined region of the medium layer;

FIG. 4 is a perspective diagram of a part of the medium layer outside of the predetermined region removed by acid or alkali;

FIG. 5 is a perspective diagram of a metal layer formed on the medium layer;

FIG. 6 illustrates a method for forming an antenna structure according to the first embodiment of the invention; and

FIG. 7 illustrates a method for forming an antenna structure according to the second embodiment of the invention.

### DETAILED DESCRIPTION OF INVENTION

### First Embodiment

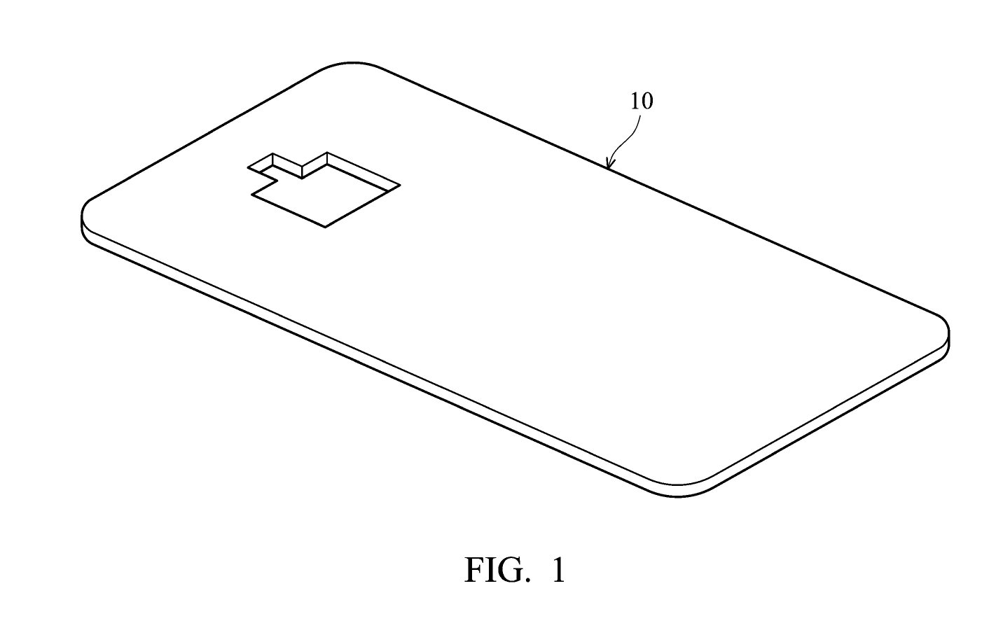

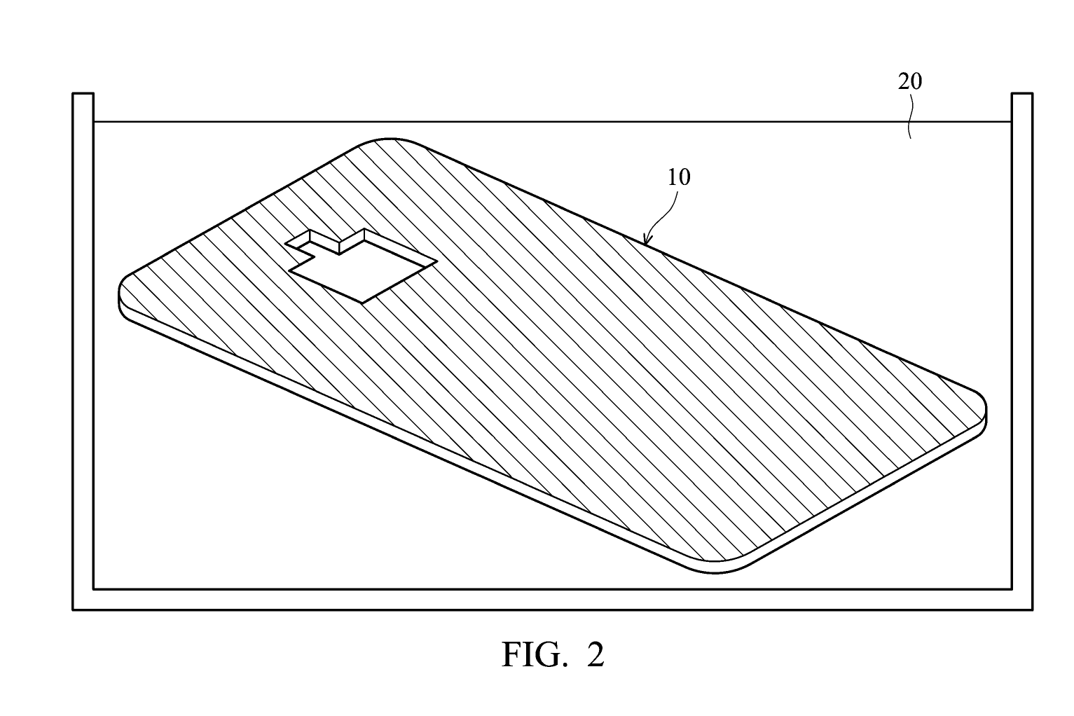

The first embodiment of the invention provides a method for forming a patterned antenna structure on a non-conductive frame. The first step of the method is to provide a non-conductive frame 10, as shown in FIG. 1. The non-conductive frame 10 may comprise polymer or plastic material integrally formed by injection molding. Subsequently, the non-conductive frame 10 is immersed in a photosensitive material to form a medium layer 20, as shown in FIG. 2. In this embodiment, the medium layer 20 may further comprise a photo resistor, UV curable material or AgBr. The medium layer 20 may further comprise an activator material of a Pb or chemical compound thereof, such as Pb/Sn colloid. Additionally, the medium layer 20 may further comprise acid, alkali or salt material with electrified particles for firmly bonding metal material to the medium layer 20 by electroless deposition. In some embodiments, the medium layer 20 can also be formed by spraying or printing a photosensitive material on the non-conductive frame 10.

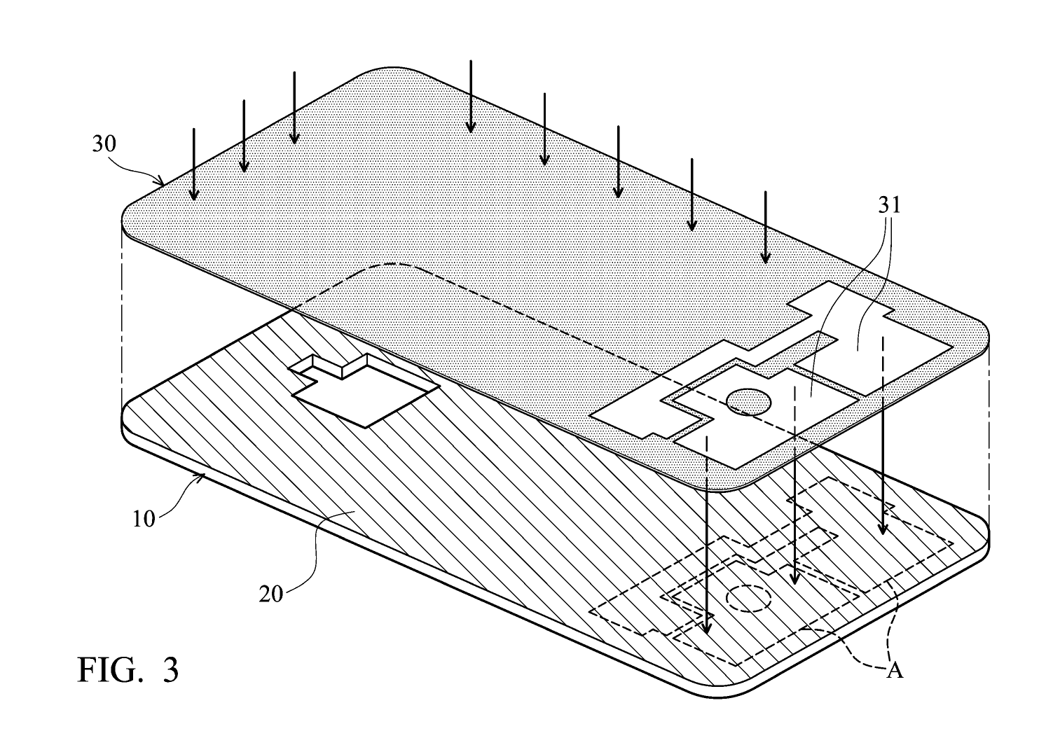

Referring to FIG. 3, a light beam is applied through a mask 30 to a predetermined region A of the medium layer 20, wherein the mask 30 has a transparent portion 31 corresponding to the predetermined region A. In this embodiment, the light beam may be UV light, and the medium layer 20 may comprise photosensitive material with a catalyzer for electroless deposition. When UV light is projected through the transparent portion 31 onto the medium layer 20, the medium layer 20 within the predetermined region A is solidified and firmly bonded to the non-conductive frame 10. Thus, a patterned antenna structure consistent with the predetermined region A can be formed on the medium layer 20 by electroless deposition.

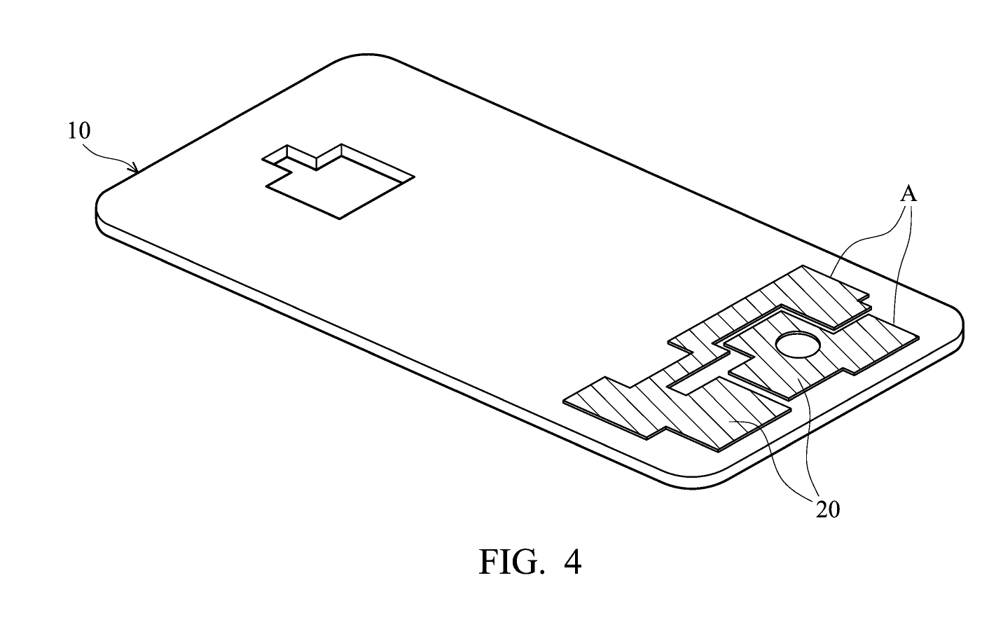

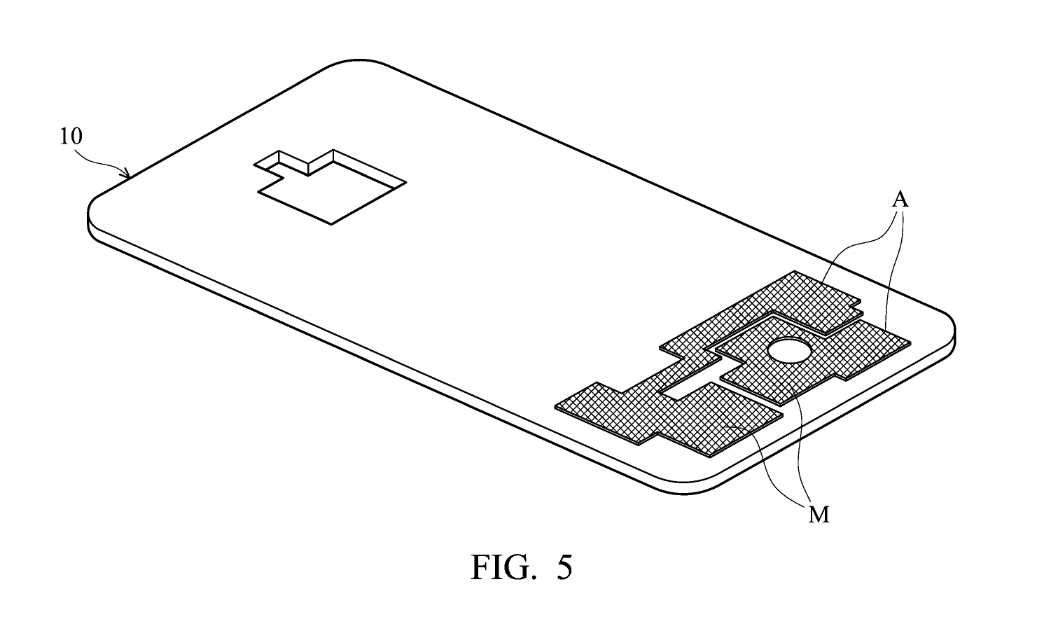

Before forming the antenna, as shown in FIG. 4, only a part of the medium layer 20, outside of the predetermined region A, can be removed by acid or alkali as the medium layer 20 within the predetermined region A has been cured and solidified. Referring to FIG. 5, a metal layer M is subsequently formed on the medium layer 20 within the predetermined region A by electroless deposition. Thus, a patterned antenna structure can be produced on the non-conductive frame 10. In this embodiment, the medium layer 20 within the predetermined region A is cured and solidified in advance, and only the part of the medium layer 20 outside of the predetermined region A is removed by acid or alkali. Additionally, since the medium layer 20 comprises activator material, such as Pb or Pb/Sn colloid, the metal layer M can be firmly bonded thereto as the patterned antenna. In some embodiments, the metal layer M may comprise Cu, Ni, Au, or Ag, and the patterned antenna structure is shaped corresponding to the predetermined region A.

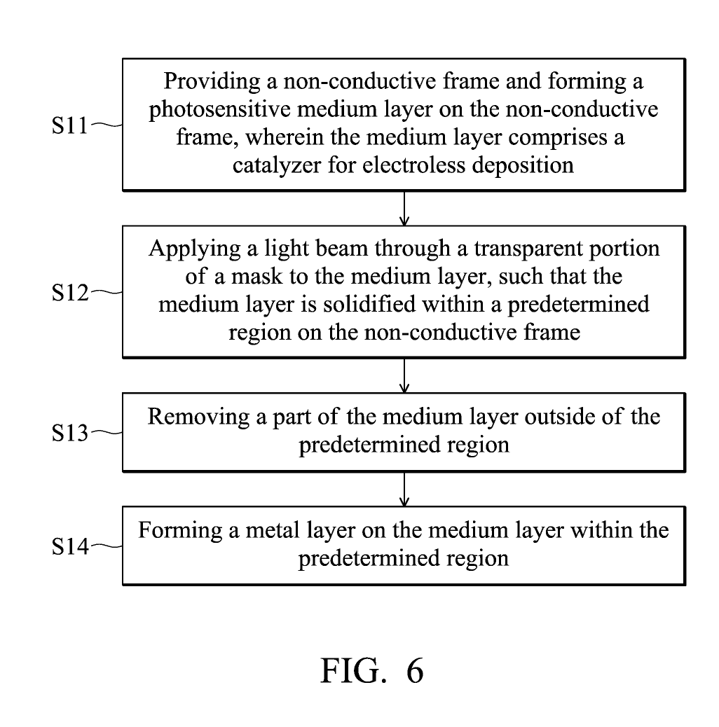

FIG. 6 illustrates the first embodiment of a method for forming an antenna structure, which primarily comprises the steps of: providing a non-conductive frame and forming a photosensitive medium layer on the non-conductive frame (step S11), wherein the medium layer comprises a catalyzer for electroless deposition; applying a light beam through a transparent portion of a mask to the medium layer, such that the medium layer is solidified within a predetermined region on the non-conductive frame (step S12); removing a part of the medium layer outside of the predetermined region (step S13); forming a metal layer on the medium layer within the predetermined region (step S14).

### Second Embodiment

The second embodiment of the invention provides a method for forming a patterned antenna structure on a non-conductive frame. Similar to the first embodiment, the first step is to provide a non-conductive frame 10 as shown in FIG. 1. The non-conductive frame 10 may comprise polymer or plastic material integrally formed by injection molding. Subsequently, the non-conductive frame 10 is immersed in a photosensitive material to form a medium layer 20, as shown in FIG. 2. In this embodiment, the medium layer 20 may further comprise a photo resistor, UV curable material or AgBr. The medium layer 20 may further comprise resin for adsorbing Pb or chemical compound thereof, such as Pb/Sn colloid. Thus, a metal material can be firmly bonded to the medium layer 20 by electroless deposition. In some embodiments, the medium layer 20 can also be formed by spraying or printing a photosensitive material on the non-conductive frame 10.

Referring to FIG. 3, a light beam is applied through a mask 30 to a predetermined region A of the medium layer 20, wherein the mask 30 has a transparent portion 31 corresponding to the predetermined region A. In this embodiment, the light beam may be UV light, and the medium layer 20 may comprise a compound of photosensitive material and resin for adsorbing Pb or Pb/Sn colloid. When UV light is projected through the transparent portion 31 onto the medium layer 20, the medium layer 20 within the predetermined region A is solidified and firmly bonded to the non-conductive frame 10. Thus, a patterned antenna structure consistent with the predetermined region A can be formed on the medium layer 20 within the predetermined region A by electroless deposition.

Before forming the antenna, as shown in FIG. 4, only a part of the medium layer 20 outside of the predetermined region A is removed by acid or alkali because the medium layer 20 within the predetermined region A has been cured and solidified. Referring to FIG. 5, a metal layer M is subsequently formed on the medium layer 20 within the predetermined region A by electroless deposition. Thus, a patterned antenna structure can be produced on the non-conductive frame 10. In this embodiment, the medium layer 20 within the predetermined region A is cured and solidified in advance, and only the part of the medium layer 20 outside of the predetermined region A is removed by acid or alkali. Additionally, since the medium layer 20 comprises activator material, such as Pb or Pb/Sn colloid, the metal layer M can be firmly bonded thereto as the patterned antenna. In some embodiments, the metal layer M may comprise Cu, Ni, Au, or Ag, and the patterned antenna structure is shaped corresponding to the predetermined region A.

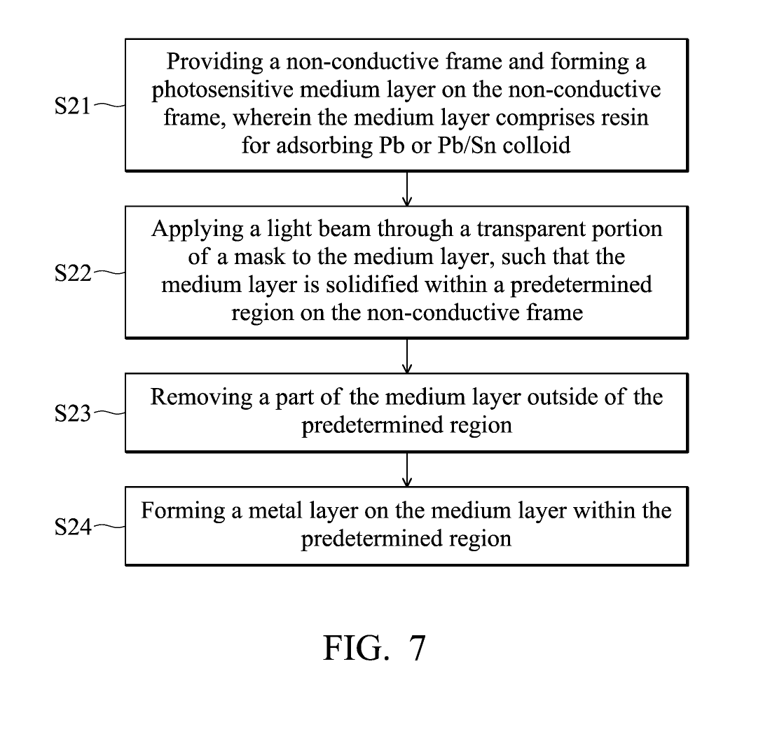

FIG. 7 illustrates the second embodiment of a method for forming an antenna structure, which primarily comprises the steps of: providing a non-conductive frame and forming a photosensitive medium layer on the non-conductive frame (step S21), wherein the medium layer comprises resin for adsorbing Pb or Pb/Sn colloid; applying a light beam through a transparent portion of a mask to the medium layer, such that the medium layer is solidified within a predetermined region on the non-conductive frame (step S22); removing a part of the medium layer outside of the predetermined region (step S23); forming a metal layer on the medium layer within the predetermined region (step S24). Since the method of the invention does not require additional metal components during production processes, assembly can be simplified and production cost can be saved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A method for forming an antenna structure, comprising:
providing a non-conductive frame and forming a photosensitive medium layer on the non-conductive frame, wherein the medium layer comprises a catalyzer for electroless deposition;
providing a mask and applying a light beam through a transparent portion of the mask to the medium layer, such that a part of the medium layer is solidified within a predetermined region on the non-conductive frame;
removing a part of the medium layer outside of the predetermined region; and
forming a metal layer on the medium layer within the predetermined region.

2. The method as claimed in claim 1, wherein the medium layer comprises Pb.

3. The method as claimed in claim 1, wherein the medium layer further comprises resin for adsorbing Pb.

4. The method as claimed in claim 1, wherein the medium layer comprises acid, alkali or salt material with electrified particles.

5. The method as claimed in claim 1, wherein the light beam is ultraviolet light (UV), and the medium layer comprises a photo resistor, UV curable material or AgBr.

6. The method as claimed in claim 1, wherein the metal layer is formed on the medium layer by electroless deposition.

7. The method as claimed in claim 1, wherein the non-conductive frame is immersed in a photosensitive material to form the medium layer.

8. The method as claimed in claim 1, wherein the medium layer is formed by spraying or printing a photosensitive material on the non-conductive frame.

9. The method as claimed in claim 1, wherein the metal layer comprises Cu, Ni, Au or Ag.

10. The method as claimed in claim 1, wherein the non-conductive frame comprises polymer or plastic material integrally formed by injection molding.
